(19) United States
(12) Patent Application Publication
(10) Pub. No.: US 2013/0059750 A1
(43) Pub. Date: Mar. 7, 2013

(54) BIOMARKERS

(71) Applicants: Sabine Bahn, Cambridge (GB); Marlis Huebner, Cambridge (GB)

(72) Inventors: Sabine Bahn, Cambridge (GB); Marlis Huebner, Cambridge (GB)

(73) Assignee: PSYNOVA NEUROTECH LTD., Cambridge (GB)

(21) Appl. No.: 13/575,704

(22) PCT Filed: Jan. 28, 2011
(86) PCT No.: PCT/GB11/50138

§ 371 Date: Nov. 15, 2012

(30) Foreign Application Priority Data
Jan. 29, 2010 (GB) 1001419.9

(51) Int. Cl. C40B 30/04; C40B 30/10

(52) U.S. Cl. 506/9; 506/12

(57) ABSTRACT

The invention relates to a method of diagnosing or monitoring schizophrenia or other psychotic disorder.

### FIELD OF THE INVENTION

The invention relates to a method of diagnosing or monitoring schizophrenia or other psychotic disorder.

### BACKGROUND OF THE INVENTION

Schizophrenia is a psychiatric diagnosis that describes a mental disorder characterized by abnormalities in the perception or expression of reality. It most commonly manifests as auditory hallucinations, paranoid or bizarre delusions, or disorganized speech and thinking with significant social or occupational dysfunction. Onset of symptoms typically occurs in young adulthood, with approximately 0.4-0.6% of the population affected. Diagnosis is based on the patient's self-reported experiences and observed behavior. No laboratory test for schizophrenia currently exists.

Studies suggest that genetics, early environment, neurobiology, psychological and social processes are important contributory factors; some recreational and prescription drugs appear to cause or worsen symptoms. Current psychiatric research is focused on the role of neurobiology, but no single organic cause has been found. Due to the many possible combinations of symptoms, there is debate about whether the diagnosis represents a single disorder or a number of discrete syndromes.

The disorder is thought to mainly affect cognition, but it also usually contributes to chronic problems with behavior and emotion. People with schizophrenia are likely to have additional (comorbid) conditions, including major depression and anxiety disorders; the lifetime occurrence of substance abuse is around 40%. Social problems, such as long-term unemployment, poverty and homelessness, are common. Furthermore, the average life expectancy of people with the disorder is 10 to 12 years less than those without, due to increased physical health problems and a higher suicide rate.

An important utility of biomarkers for psychotic disorders is their response to medication. Administration of antipsychotics remains a subjective process, relying solely on the experience of clinicians. Furthermore, the development of antipsychotic drugs has been based on chance findings often with little relation to the background driving the observations.

Schizophrenia is treated primarily with antipsychotic medications which are also referred to as neuroleptic drugs or neuroleptics. Newer antipsychotic agents such as Clozapine, Olanzapine, Quetiapine or Risperidone are thought to be more effective in improving negative symptoms of psychotic disorders than older medication like Chlorpromazine. Furthermore, they induce less extrapyramidal side effects (EPS) which are movement disorders resulting from antipsychotic treatment.

The history of neuroleptics dates back to the late 19th century. The flourishing dye industry catalyzed development of new chemicals that lay the background to modern day atypical antipsychotics. Developments in anti malaria, antihistamine and anaesthetic compounds also produced various neuroleptics. The common phenomenon to all these processes is a fundamental lack of understanding of the biological mechanisms and pathways that these drugs affect, apart from the observation that they prominently block D2 receptors in the striatum.

There is therefore a pressing need for objective molecular readouts that can diagnose schizophrenia or other psychotic disorders and furthermore indicate whether a patient is responding to medication, as well as for predicting prognosis.

### SUMMARY OF THE INVENTION

According to a first aspect of the invention, there is provided the use of Matrix Metallopeptidase-3 (MMP-3), Thyroid Stimulating Hormone (TSH) and IL-18 as a specific panel of biomarkers for schizophrenia or other psychotic disorder, or predisposition thereto.

According to a second aspect of the invention, there is provided the use of Matrix Metallopeptidase-3 (MMP-3), Thyroid Stimulating Hormone (TSH), IL-18, EN-RAGE, Angiotensin Converting Enzyme (ACE), α-2 macroglobulin (A2M), Progesterone, Plasminogen Activator Inhibitor-1 (PAI-1) and Myeloperoxidase as a specific panel of analyte biomarkers for schizophrenia or other psychotic disorder, or predisposition thereto.

According to a further aspect of the invention, there is provided a method of diagnosing or monitoring schizophrenia or other psychotic disorder, or predisposition thereto, comprising detecting and/or quantifying, in a sample from a test subject, the analyte biomarkers defined herein.

According to a further aspect of the invention, there is provided a method of monitoring efficacy of a therapy in a subject having, suspected of having, or of being predisposed to schizophrenia or other psychotic disorder, comprising detecting and/or quantifying, in a sample from said subject, the analyte biomarkers defined herein.

A further aspect of the invention provides ligands, such as naturally occurring or chemically synthesised compounds, capable of specific binding to the analyte biomarker. A ligand according to the invention may comprise a peptide, an antibody or a fragment thereof, or an aptamer or oligonucleotide, capable of specific binding to the analyte biomarker. The antibody can be a monoclonal antibody or a fragment thereof capable of specific binding to the analyte biomarker. A ligand according to the invention may be labelled with a detectable marker, such as a luminescent, fluorescent or radioactive marker; alternatively or additionally a ligand according to the invention may be labelled with an affinity tag, e.g. a biotin, avidin, streptavidin or His (e.g. hexa-His) tag.

A biosensor according to the invention may comprise the analyte biomarker or a structural/shape mimic thereof capable of specific binding to an antibody against the analyte biomarker. Also provided is an array comprising a ligand or mimic as described herein.

Also provided by the invention is the use of one or more ligands as described herein, which may be naturally occurring or chemically synthesised, and is suitably a peptide, antibody or fragment thereof, aptamer or oligonucleotide, or the use of a biosensor of the invention, or an array of the invention, or a kit of the invention to detect and/or quantify the analyte. In these uses, the detection and/or quantification can be performed on a biological sample such as from the group consisting of CSF, whole blood, blood serum, plasma, urine, saliva, or other bodily fluid, breath, e.g. as condensed breath, or an extract or purification therefrom, or dilution thereof.

Diagnostic or monitoring kits are provided for performing methods of the invention. Such kits will suitably comprise a ligand according to the invention, for detection and/or quantification of the analyte biomarker, and/or a biosensor, and/or an array as described herein, optionally together with instructions for use of the kit.

A further aspect of the invention is a kit for monitoring or diagnosing schizophrenia or other psychotic disorder, comprising a biosensor capable of detecting and/or quantifying the analyte biomarkers as defined herein.

Biomarkers for schizophrenia or other psychotic disorders are essential targets for discovery of novel targets and drug molecules that retard or halt progression of the disorder. As the level of the analyte biomarker is indicative of disorder and of drug response, the biomarker is useful for identification of novel therapeutic compounds in in vitro and/or in vivo assays. Biomarkers of the invention can be employed in methods for screening for compounds that modulate the activity of the analyte.

Thus, in a further aspect of the invention, there is provided the use of a ligand, as described, which can be a peptide, antibody or fragment thereof or aptamer or oligonucleotide according to the invention; or the use of a biosensor according to the invention, or an array according to the invention; or a kit according to the invention, to identify a substance capable of promoting and/or of suppressing the generation of the biomarker.

Also there is provided a method of identifying a substance capable of promoting or suppressing the generation of the analyte in a subject, comprising administering a test substance to a subject animal and detecting and/or quantifying the level of the analyte biomarker present in a test sample from the subject.

### BRIEF DESCRIPTION OF THE FIGURES

FIG. 1: Assessment of data quality and structure. Left panels show the separation between unstimulated (grey) and stimulated (black) TruCulture systems in both sample cohorts (ellipse indicates 95% confidence interval). Right panels show the respective loadings plots contributing to the separation. Analytes that cluster together share changes in expression levels which can be unchanged, increased or decreased upon stimulation.

FIG. 2: Stimulation index of the reproducible differentially expressed analytes. Shown is the stimulation index of the most reproducible differentially expressed analytes between schizophrenia patients (SZ) and healthy control (HC) subjects. The stimulation index is calculated as the ratio of measured analyte concentration in the stimulated to unstimulated condition.

FIG. 3: Correlation and Ingenuity Pathway Analysis networks (A) Correlation networks for the 9 reproducible differentially expressed analytes between schizophrenia patients and healthy controls. Correlations (indicated by lines) between analytes were considered significant for a Pearson correlation coefficient of P<0.4, P<−0.4 and a P-value of p<0.05. (B) Ingenuity Pathway Analysis (IPA) networks for the same 9 analytes (coloured in light grey and dark grey). White-coloured analytes were added according to IPA criteria. Links between analytes represent their biological relation based on at least one publication.

FIG. 4: Molecular interaction of differentially expressed analytes. Simplified scheme illustrating the biological relationship between plasma analytes and their involvement in the coagulation system and the acute phase response. Analytes were significantly decreased (dark grey), unchanged (pale grey) or not measured (white) in patients compared to controls. Plasmin, a serine protease, promotes fibrinolysis which results in the increased release of fibrinogen degradation products (FDP). Plasmin is inhibited indirectly by plasmin activator inhibitor-1 (PAI-1) through the inactivation of tissue plasminogen activator (tPA) which promotes formation of plasmin from plasminogen. Alpha-2 macroglobulin (A2M) exerts its antifibrinogenic actions through inhibition of plasmin, active matrix metalloproteases (MMP) and thrombin which converts fibrinogen to fibrin. The active forms of MMP3 and transforming growth factor-β (TGF-β) are generated by plasmin. TGF-β plays dual roles as an inhibitor of tPA and MMP3 and as an activator of PAI and A2M. PAI-1, A2M and IL-18 are key components of the acute phase response. PAI-1 and angiotensin converting enzyme (ACE) are potent inducers of vasoconstrictors. ACE further degrades bradykinin, a vasodilator that increases together with FDP vascular permeability.

### DETAILED DESCRIPTION OF THE INVENTION

The term “biomarker” means a distinctive biological or biologically derived indicator of a process, event, or condition. Analyte biomarkers can be used in methods of diagnosis, e.g. clinical screening, and prognosis assessment and in monitoring the results of therapy, identifying patients most likely to respond to a particular therapeutic treatment, drug screening and development. Biomarkers and uses thereof are valuable for identification of new drug treatments and for discovery of new targets for drug treatment.

It will be readily apparent to the skilled person that the analytes listed herein are known and have been described in the literature.

According to a first aspect of the invention, there is provided the use of Matrix Metallopeptidase-3 (MMP-3), Thyroid Stimulating Hormone (TSH) and IL-18 as a specific panel of biomarkers for schizophrenia or other psychotic disorder, or predisposition thereto.

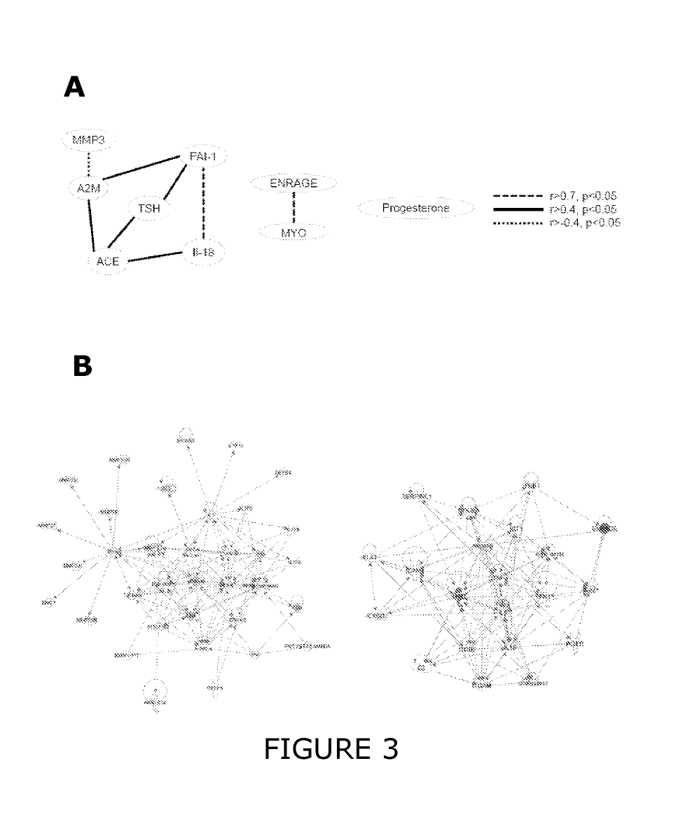

Data is presented in Tables 2 and 3 herein which demonstrates that the 3 analytes of the first aspect of the invention were significantly decreased in schizophrenia patients when compared with healthy controls. The results obtained with the 3 analytes of this aspect of the invention were also observed to be reproducible. Furthermore, it can be seen from FIG. 3 that each of the 3 analytes of this aspect of the invention form both correlation and ingenuity pathway analysis networks.

In one embodiment of the first aspect of the invention, the use additionally comprises one or more additional analytes selected from: Creatine kinase-MB, Angiotensin Converting Enzyme (ACE), Cortisol, Thyroxine Binding Globulin (TBG), α-2 macroglobulin (A2M), Thrombopoietin, Inter-Cellular Adhesion Molecule-1 (ICAM-1), IL-6, EN-RAGE, Plasminogen Activator Inhibitor-1 (PAI-1), Epidermal Growth Factor (EGF), Leptin, Myeloperoxidase, Angiotensinogen and Stem Cell Factor.

In one embodiment of the first aspect of the invention, the additional analytes are selected from Creatine kinase-MB, Angiotensin Converting Enzyme (ACE), Cortisol, Thyroxine Binding Globulin (TBG), α-2 macroglobulin (A2M), Thrombopoietin and Inter-Cellular Adhesion Molecule-1 (ICAM-1).

In a further embodiment of the first aspect of the invention, the additional analytes are selected from Plasminogen Activator Inhibitor-1 (PAI-1), Angiotensin Converting Enzyme (ACE) and α-2 macroglobulin (A2M). Data is presented in Tables 2 and 3 herein which demonstrates that the 3 analytes of this embodiment were significantly decreased in schizophrenia patients when compared with healthy controls. The results obtained with the 3 analytes of this embodiment were also observed to be reproducible. Furthermore, it can be seen from FIG. 3 that each of the 3 analytes of this embodiment form both correlation and ingenuity pathway analysis networks. Thus, according to a further aspect of the invention there is provided the use of Plasminogen Activator Inhibitor-1 (PAI-1), Angiotensin Converting Enzyme (ACE) and α-2 macroglobulin (A2M) as a specific panel of biomarkers for schizophrenia or other psychotic disorder, or predisposition thereto.

In one embodiment of the first aspect of the invention, the additional analytes are selected from IL-6, EN-RAGE, Plasminogen Activator Inhibitor-1 (PAI-1), Epidermal Growth Factor (EGF), Leptin, Myeloperoxidase, Thrombopoietin, Angiotensinogen and Stem Cell Factor.

In a further embodiment of the first aspect of the invention, the additional analytes are selected from EN-RAGE, Plasminogen Activator Inhibitor-1 (PAI-1) and Myeloperoxidase, such as EN-RAGE.

In one embodiment of the first aspect of the invention, the use additionally comprises progesterone as an additional analyte.

According to one particular aspect of the invention which may be mentioned, there is provided the use of a first analyte selected from progesterone as a biomarker for schizophrenia or other psychotic disorder, or predisposition thereto.

In one embodiment of any of the aforementioned aspects of the invention, the use additionally comprises one or more second analytes selected from: Creatine kinase-MB, Matrix Metallopeptidase-3 (MMP-3), Angiotensin Converting Enzyme (ACE), Cortisol, Thyroxine Binding Globulin (TBG), α-2 macroglobulin (A2M), Thrombopoietin, Thyroid Stimulating Hormone (TSH), Inter-Cellular Adhesion Molecule-1 (ICAM-1), IL-6, IL-18, EN-RAGE, Plasminogen Activator Inhibitor-1 (PAI-1), Epidermal Growth Factor (EGF), Leptin, Myeloperoxidase, Angiotensinogen and Stem Cell Factor.

According to a second aspect of the invention, there is provided the use of two or more second analytes selected from: Creatine kinase-MB, Matrix Metallopeptidase-3 (MMP-3), Angiotensin Converting Enzyme (ACE), Cortisol, Thyroxine Binding Globulin (TBG), α-2 macroglobulin (A2M), Thrombopoietin, Thyroid Stimulating Hormone (TSH), Inter-Cellular Adhesion Molecule-1 (ICAM-1), IL-6, IL-18, EN-RAGE, Plasminogen Activator Inhibitor-1 (PAI-1), Epidermal Growth Factor (EGF), Leptin, Myeloperoxidase, Angiotensinogen and Stem Cell Factor as a biomarker for schizophrenia or other psychotic disorder, or predisposition thereto.

In one embodiment of any of the aforementioned aspects of the invention, the second analyte is selected from Creatine kinase-MB, Matrix Metallopeptidase-3 (MMP-3), Angiotensin Converting Enzyme (ACE), Cortisol, Thyroxine Binding Globulin (TBG), α-2 macroglobulin (A2M), Thrombopoietin, Thyroid Stimulating Hormone (TSH) and Inter-Cellular Adhesion Molecule-1 (ICAM-1). Data is presented in Table 2 herein which identifies that these second analytes were altered in schizophrenia patients irrespective of stimulation condition.

In one embodiment of any of the aforementioned aspects of the invention, the second analyte is selected from Matrix Metallopeptidase-3 (MMP-3), Angiotensin Converting Enzyme (ACE), α-2 macroglobulin (A2M) and Thyroid Stimulating Hormone (TSH). Data is presented in Table 2 herein which identifies that these second analytes were altered in schizophrenia patients irrespective of stimulation condition and were reproducible across both cohorts.

In one embodiment of any of the aforementioned aspects of the invention, the second analyte is selected from IL-6, IL-18, EN-RAGE, Plasminogen Activator Inhibitor-1 (PAI-1), Epidermal Growth Factor (EGF), Leptin, Myeloperoxidase, Thrombopoietin, Angiotensinogen and Stem Cell Factor. Data is presented in Table 3 herein which identifies that these second analytes were altered in schizophrenia patients depending upon the stimulation condition.

In one embodiment of any of the aforementioned aspects of the invention, the second analyte is selected from IL-18, EN-RAGE, Plasminogen Activator Inhibitor-1 (PAI-1) and Myeloperoxidase. Data is presented in Table 3 herein which identifies that these second analytes were altered in schizophrenia patients depending upon the stimulation condition and were reproducible across both cohorts.

In one embodiment of any of the aforementioned aspects of the invention, the second analyte is selected from IL-18 and EN-RAGE. Data is presented in Table 3 herein which identifies that these second analytes were altered in schizophrenia patients depending upon the stimulation condition and were reproducible across both cohorts with more than a borderline significance.

Dynamic molecular signatures before and after lymphocyte activation were assessed in schizophrenia patients using an ex vivo whole blood culture system. The expression levels of 107 immune and metabolic analytes in plasma supernatants of 17 antipsychotic-naïve schizophrenia patients and 17 matched healthy controls were profiled. The study was performed using two independent sample cohorts recruited at two clinical sites. Differential expression of 9 plasma analytes was consistent in both cohorts. Thus according to a second aspect of the invention, there is provided the use of Matrix Metallopeptidase-3 (MMP-3), Angiotensin Converting Enzyme (ACE), α-2 macroglobulin (A2M), Thyroid Stimulating Hormone (TSH), Progesterone, IL-18, EN-RAGE, Plasminogen Activator Inhibitor-1 (PAI-1) and Myeloperoxidase as a specific panel of analyte biomarkers for schizophrenia or other psychotic disorder, or predisposition thereto.

Of these, 4 analytes were differentially expressed between patients and controls regardless of stimulation condition. Thus according to a further aspect of the invention, there is provided the use of Matrix Metallopeptidase-3 (MMP-3), Angiotensin Converting Enzyme (ACE), α-2 macroglobulin (A2M) and Thyroid Stimulating Hormone (TSH) as a specific panel of analyte biomarkers for schizophrenia or other psychotic disorder, or predisposition thereto.

Furthermore, 5 analytes were differentially regulated between patients and controls upon stimulation demonstrating that patients exert an immune response that distinguishes them from healthy controls. Thus according to a further aspect of the invention, there is provided the use of Progesterone, IL-18, EN-RAGE, Plasminogen Activator Inhibitor-1 (PAI-1) and Myeloperoxidase as a specific panel of analyte biomarkers for schizophrenia or other psychotic disorder, or predisposition thereto.

Correlation analysis showed that analytes decreased in schizophrenia formed a separate correlation network from analytes that were increased in these subjects. Although most of these analytes shared common roles in endothelial dysfunction and inflammation these networks might explain their antagonistic effects on each other. Furthermore, in silico pathway analysis showed that all analytes with decreased expression levels in schizophrenia were associated with the acute phase response and the coagulation/fibrinolytic system. These results presented herein show that only the combination of static and dynamic peripheral events leads to the identification of functionally relevant immune and metabolic signatures in schizophrenia that are reproducible even across small sample cohorts.

In one embodiment, one or more of the biomarkers may be replaced by a molecule, or a measurable fragment of the molecule, found upstream or downstream of the biomarker in a biological pathway.

References herein to “other psychotic disorder” relate to any appropriate psychotic disorder according to DSM-IV Diagnostic and Statistical Manual of Mental Disorders, 4th edition, American Psychiatric Assoc, Washington, D.C., 2000. In one particular embodiment, the other psychotic disorder is a psychotic disorder related to schizophrenia. Examples of psychotic disorders related to schizophrenia include brief psychotic disorder delusional disorder, psychotic disorder due to a general medical condition, schizoeffective disorder, schizophreniform disorder, and substance-induced psychotic disorder.

As used herein, the term “biosensor” means anything capable of detecting the presence of the biomarker. Examples of biosensors are described herein.

Biosensors according to the invention may comprise a ligand or ligands, as described herein, capable of specific binding to the analyte biomarker. Such biosensors are useful in detecting and/or quantifying an analyte of the invention.

Diagnostic kits for the diagnosis and monitoring of schizophrenia or other psychotic disorder are described herein. In one embodiment, the kits additionally contain a biosensor capable of detecting and/or quantifying an analyte biomarker.

Monitoring methods of the invention can be used to monitor onset, progression, stabilisation, amelioration and/or remission.

In methods of diagnosing or monitoring according to the invention, detecting and/or quantifying the analyte biomarker in a biological sample from a test subject may be performed on two or more occasions. Comparisons may be made between the level of biomarker in samples taken on two or more occasions. Assessment of any change in the level of the analyte biomarker in samples taken on two or more occasions may be performed. Modulation of the analyte biomarker level is useful as an indicator of the state of schizophrenia or other psychotic disorder or predisposition thereto. An increase in the level of the biomarker, over time is indicative of onset or progression, i.e. worsening of this disorder, whereas a decrease in the level of the analyte biomarker indicates amelioration or remission of the disorder, or vice versa.

A method of diagnosis or monitoring according to the invention may comprise quantifying the analyte biomarker in a test biological sample from a test subject and comparing the level of the analyte present in said test sample with one or more controls.

The control used in a method of the invention can be one or more control(s) selected from the group consisting of: the level of biomarker analyte found in a normal control sample from a normal subject, a normal biomarker analyte level; a normal biomarker analyte range, the level in a sample from a subject with schizophrenia or other psychotic disorder, or a diagnosed predisposition thereto; schizophrenia or other psychotic disorder biomarker analyte level, or schizophrenia or other psychotic disorder biomarker analyte range.

In one embodiment, there is provided a method of diagnosing schizophrenia or other psychotic disorder, or predisposition thereto, which comprises:
(a) quantifying the amount of the analyte biomarker in a test biological sample; and
(b) comparing the amount of said analyte in said test sample with the amount present in a normal control biological sample from a normal subject.

A higher level of the analyte biomarker in the test sample relative to the level in the normal control is indicative of the presence of schizophrenia or other psychotic disorder, or predisposition thereto; an equivalent or lower level of the analyte in the test sample relative to the normal control is indicative of absence of schizophrenia or other psychotic disorder and/or absence of a predisposition thereto.

The term “diagnosis” as used herein encompasses identification, confirmation, and/or characterisation of schizophrenia or other psychotic disorder, or predisposition thereto. By predisposition it is meant that a subject does not currently present with the disorder, but is liable to be affected by the disorder in time. Methods of monitoring and of diagnosis according to the invention are useful to confirm the existence of a disorder, or predisposition thereto; to monitor development of the disorder by assessing onset and progression, or to assess amelioration or regression of the disorder. Methods of monitoring and of diagnosis are also useful in methods for assessment of clinical screening, prognosis, choice of therapy, evaluation of therapeutic benefit, i.e. for drug screening and drug development.

Efficient diagnosis and monitoring methods provide very powerful “patient solutions” with the potential for improved prognosis, by establishing the correct diagnosis, allowing rapid identification of the most appropriate treatment (thus lessening unnecessary exposure to harmful drug side effects), reducing relapse rates.

Also provided is a method of monitoring efficacy of a therapy for schizophrenia or other psychotic disorder in a subject having such a disorder, suspected of having such a disorder, or of being predisposed thereto, comprising detecting and/or quantifying the analyte present in a biological sample from said subject. In monitoring methods, test samples may be taken on two or more occasions. The method may further comprise comparing the level of the biomarker(s) present in the test sample with one or more control(s) and/or with one or more previous test sample(s) taken earlier from the same test subject, e.g. prior to commencement of therapy, and/or from the same test subject at an earlier stage of therapy. The method may comprise detecting a change in the level of the biomarker(s) in test samples taken on different occasions.

The invention provides a method for monitoring efficacy of therapy for schizophrenia or other psychotic disorder in a subject, comprising:
(a) quantifying the amount of the analyte biomarker; and
(b) comparing the amount of said analyte in said test sample with the amount present in one or more control(s) and/or one or more previous test sample(s) taken at an earlier time from the same test subject.

A decrease in the level of the analyte biomarker in the test sample relative to the level in a previous test sample taken earlier from the same test subject is indicative of a beneficial effect, e.g. stabilisation or improvement, of said therapy on the disorder, suspected disorder or predisposition thereto.

Methods for monitoring efficacy of a therapy can be used to monitor the therapeutic effectiveness of existing therapies and new therapies in human subjects and in non-human animals (e.g. in animal models). These monitoring methods can be incorporated into screens for new drug substances and combinations of substances.

Suitably, the time elapsed between taking samples from a subject undergoing diagnosis or monitoring will be 3 days, 5 days, a week, two weeks, a month, 2 months, 3 months, 6 or 12 months. Samples may be taken prior to and/or during and/or following an anti-psychotic therapy. Samples can be taken at intervals over the remaining life, or a part thereof, of a subject.

The term “detecting” as used herein means confirming the presence of the analyte biomarker present in the sample. Quantifying the amount of the biomarker present in a sample may include determining the concentration of the analyte biomarker present in the sample. Detecting and/or quantifying may be performed directly on the sample, or indirectly on an extract therefrom, or on a dilution thereof.

In alternative aspects of the invention, the presence of the analyte biomarker is assessed by detecting and/or quantifying antibody or fragments thereof capable of specific binding to the biomarker that are generated by the subject's body in response to the analyte and thus are present in a biological sample from a subject having schizophrenia or other psychotic disorder or a predisposition thereto.

Detecting and/or quantifying can be performed by any method suitable to identify the presence and/or amount of a specific protein in a biological sample from a patient or a purification or extract of a biological sample or a dilution thereof. In methods of the invention, quantifying may be performed by measuring the concentration of the analyte biomarker in the sample or samples. Biological samples that may be tested in a method of the invention include cerebrospinal fluid (CSF), whole blood, blood serum, plasma, urine, saliva, or other bodily fluid (stool, tear fluid, synovial fluid, sputum), breath, e.g. as condensed breath, or an extract or purification therefrom, or dilution thereof. Biological samples also include tissue homogenates, tissue sections and biopsy specimens from a live subject, or taken post-mortem. The samples can be prepared, for example where appropriate diluted or concentrated, and stored in the usual manner.

Detection and/or quantification of analyte biomarkers may be performed by detection of the analyte biomarker or of a fragment thereof, e.g. a fragment with C-terminal truncation, or with N-terminal truncation. Fragments are suitably greater than 4 amino acids in length, for example 5, 6, 7, 8, 9, 10, 11, 12, 13, 14, 15, 16, 17, 18, 19, or 20 amino acids in length.

The biomarker may be directly detected, e.g. by SELDI or MALDI-TOF. Alternatively, the biomarker may be detected directly or indirectly via interaction with a ligand or ligands such as an antibody or a biomarker-binding fragment thereof, or other peptide, or ligand, e.g. aptamer, or oligonucleotide, capable of specifically binding the biomarker. The ligand may possess a detectable label, such as a luminescent, fluorescent or radioactive label, and/or an affinity tag.

For example, detecting and/or quantifying can be performed by one or more method(s) selected from the group consisting of: SELDI (-TOF), MALDI (-TOF), a 1-D gel-based analysis, a 2-D gel-based analysis, Mass spec (MS), reverse phase (RP) LC, size permeation (gel filtration), ion exchange, affinity, HPLC, UPLC and other LC or LC MS-based techniques. Appropriate LC MS techniques include ICAT® (Applied Biosystems, CA, USA), or iTRAQ® (Applied Biosystems, CA, USA). Liquid chromatography (e.g. high pressure liquid chromatography (HPLC) or low pressure liquid chromatography (LPLC)), thin-layer chromatography, NMR (nuclear magnetic resonance) spectroscopy could also be used.

Methods of diagnosing or monitoring according to the invention may comprise analysing a sample of cerebrospinal fluid (CSF) by SELDI TOF or MALDI TOF to detect the presence or level of the analyte biomarker. These methods are also suitable for clinical screening, prognosis, monitoring the results of therapy, identifying patients most likely to respond to a particular therapeutic treatment, for drug screening and development, and identification of new targets for drug treatment.

Detecting and/or quantifying the analyte biomarkers may be performed using an immunological method, involving an antibody, or a fragment thereof capable of specific binding to the analyte biomarker. Suitable immunological methods include sandwich immunoassays, such as sandwich ELISA, in which the detection of the analyte biomarkers is performed using two antibodies which recognize different epitopes on a analyte biomarker; radioimmunoassays (RIA), direct, indirect or competitive enzyme linked immunosorbent assays (ELISA), enzyme immunoassays (EIA), Fluorescence immunoassays (FIA), western blotting, immunoprecipitation and any particle-based immunoassay (e.g. using gold, silver, or latex particles, magnetic particles, or Q-dots). Immunological methods may be performed, for example, in microtitre plate or strip format.

Immunological methods in accordance with the invention may be based, for example, on any of the following methods.

Immunoprecipitation is the simplest immunoassay method; this measures the quantity of precipitate, which forms after the reagent antibody has incubated with the sample and reacted with the target antigen present therein to form an insoluble aggregate. Immunoprecipitation reactions may be qualitative or quantitative.

In particle immunoassays, several antibodies are linked to the particle, and the particle is able to bind many antigen molecules simultaneously. This greatly accelerates the speed of the visible reaction. This allows rapid and sensitive detection of the biomarker.

In immunonephelometry, the interaction of an antibody and target antigen on the biomarker results in the formation of immune complexes that are too small to precipitate. However, these complexes will scatter incident light and this can be measured using a nephelometer. The antigen, i.e. biomarker, concentration can be determined within minutes of the reaction.

Radioimmunoassay (RIA) methods employ radioactive isotopes such as I¹²⁵ to label either the antigen or antibody. The isotope used emits gamma rays, which are usually measured following removal of unbound (free) radiolabel. The major advantages of RIA, compared with other immunoassays, are higher sensitivity, easy signal detection, and well-established, rapid assays. The major disadvantages are the health and safety risks posed by the use of radiation and the time and expense associated with maintaining a licensed radiation safety and disposal program. For this reason, RIA has been largely replaced in routine clinical laboratory practice by enzyme immunoassays.

Enzyme (EIA) immunoassays were developed as an alternative to radioimmunoassays (RIA). These methods use an enzyme to label either the antibody or target antigen. The sensitivity of EIA approaches that for RIA, without the danger posed by radioactive isotopes. One of the most widely used EIA methods for detection is the enzyme-linked immunosorbent assay (ELISA). ELISA methods may use two antibodies one of which is specific for the target antigen and the other of which is coupled to an enzyme, addition of the substrate for the enzyme results in production of a chemiluminescent or fluorescent signal.

Fluorescent immunoassay (FIA) refers to immunoassays which utilize a fluorescent label or an enzyme label which acts on the substrate to form a fluorescent product. Fluorescent measurements are inherently more sensitive than colorimetric (spectrophotometric) measurements. Therefore, FIA methods have greater analytical sensitivity than EIA methods, which employ absorbance (optical density) measurement.

Chemiluminescent immunoassays utilize a chemiluminescent label, which produces light when excited by chemical energy; the emissions are measured using a light detector.

Immunological methods according to the invention can thus be performed using well-known methods. Any direct (e.g., using a sensor chip) or indirect procedure may be used in the detection of analyte biomarkers of the invention.

The Biotin-Avidin or Biotin-Streptavidin systems are generic labelling systems that can be adapted for use in immunological methods of the invention. One binding partner (hapten, antigen, ligand, aptamer, antibody, enzyme etc) is labelled with biotin and the other partner (surface, e.g. well, bead, sensor etc) is labelled with avidin or streptavidin. This is conventional technology for immunoassays, gene probe assays and (bio)sensors, but is an indirect immobilisation route rather than a direct one. For example a biotinylated ligand (e.g. antibody or aptamer) specific for an analyte biomarker of the invention may be immobilised on an avidin or streptavidin surface, the immobilised ligand may then be exposed to a sample containing or suspected of containing the analyte biomarker in order to detect and/or quantify an analyte biomarker of the invention. Detection and/or quantification of the immobilised antigen may then be performed by an immunological method as described herein.

The term “antibody” as used herein includes, but is not limited to: polyclonal, monoclonal, bispecific, humanised or chimeric antibodies, single chain antibodies, Fab fragments and F(ab′)₂ fragments, fragments produced by a Fab expression library, anti-idiotypic (anti-Id) antibodies and epitope-binding fragments of any of the above. The term “antibody” as used herein also refers to immunoglobulin molecules and immunologically-active portions of immunoglobulin molecules, i.e., molecules that contain an antigen binding site that specifically binds an antigen. The immunoglobulin molecules of the invention can be of any class (e.g., IgG, IgE, IgM, IgD and IgA) or subclass of immunoglobulin molecule.

The identification of key biomarkers specific to a disease is central to integration of diagnostic procedures and therapeutic regimes. Using predictive biomarkers appropriate diagnostic tools such as biosensors can be developed; accordingly, in methods and uses of the invention, detecting and quantifying can be performed using a biosensor, microanalytical system, microengineered system, microseparation system, immunochromatography system or other suitable analytical devices. The biosensor may incorporate an immunological method for detection of the biomarker(s), electrical, thermal, magnetic, optical (e.g. hologram) or acoustic technologies. Using such biosensors, it is possible to detect the target biomarker(s) at the anticipated concentrations found in biological samples.

Thus, according to a further aspect of the invention there is provided an apparatus for diagnosing or monitoring schizophrenia or other psychotic disorders which comprises a biosensor, microanalytical, microengineered, microseparation and/or immunochromatography system configured to detect and/or quantify any of the biomarkers defined herein.

The biomarker(s) of the invention can be detected using a biosensor incorporating technologies based on “smart” holograms, or high frequency acoustic systems, such systems are particularly amenable to “bar code” or array configurations.

In smart hologram sensors (Smart Holograms Ltd, Cambridge, UK), a holographic image is stored in a thin polymer film that is sensitised to react specifically with the biomarker. On exposure, the biomarker reacts with the polymer leading to an alteration in the image displayed by the hologram. The test result read-out can be a change in the optical brightness, image, colour and/or position of the image. For qualitative and semi-quantitative applications, a sensor hologram can be read by eye, thus removing the need for detection equipment. A simple colour sensor can be used to read the signal when quantitative measurements are required. Opacity or colour of the sample does not interfere with operation of the sensor. The format of the sensor allows multiplexing for simultaneous detection of several substances. Reversible and irreversible sensors can be designed to meet different requirements, and continuous monitoring of a particular biomarker of interest is feasible.

Suitably, biosensors for detection of one or more biomarkers of the invention combine biomolecular recognition with appropriate means to convert detection of the presence, or quantitation, of the biomarker in the sample into a signal. Biosensors can be adapted for “alternate site” diagnostic testing, e.g. in the ward, outpatients' department, surgery, home, field and workplace.

Biosensors to detect one or more biomarkers of the invention include acoustic, plasmon resonance, holographic and microengineered sensors. Imprinted recognition elements, thin film transistor technology, magnetic acoustic resonator devices and other novel acousto-electrical systems may be employed in biosensors for detection of the one or more biomarkers of the invention.

Methods involving detection and/or quantification of one or more analyte biomarkers of the invention can be performed on bench-top instruments, or can be incorporated onto disposable, diagnostic or monitoring platforms that can be used in a non-laboratory environment, e.g. in the physician's office or at the patient's bedside. Suitable biosensors for performing methods of the invention include “credit” cards with optical or acoustic readers. Biosensors can be configured to allow the data collected to be electronically transmitted to the physician for interpretation and thus can form the basis for e-neuromedicine.

Any suitable animal may be used as a subject non-human animal, for example a non-human primate, horse, cow, pig, goat, sheep, dog, cat, fish, rodent, e.g. guinea pig, rat or mouse; insect (e.g. Drosophila), amphibian (e.g. Xenopus) or C. elegans.

The test substance can be a known chemical or pharmaceutical substance, such as, but not limited to, an anti-psychotic disorder therapeutic; or the test substance can be novel synthetic or natural chemical entity, or a combination of two or more of the aforesaid substances.

There is provided a method of identifying a substance capable of promoting or suppressing the generation of the analyte biomarker in a subject, comprising exposing a test cell to a test substance and monitoring the level of the analyte biomarker within said test cell, or secreted by said test cell.

The test cell could be prokaryotic, however a eukaryotic cell will suitably be employed in cell-based testing methods. Suitably, the eukaryotic cell is a yeast cell, insect cell, Drosophila cell, amphibian cell (e.g. from Xenopus), C. elegans cell or is a cell of human, non-human primate, equine, bovine, porcine, caprine, ovine, canine, feline, piscine, rodent or murine origin.

In methods for identifying substances of potential therapeutic use, non-human animals or cells can be used that are capable of expressing the analyte.

Screening methods also encompass a method of identifying a ligand capable of binding to the analyte biomarker according to the invention, comprising incubating a test substance in the presence of the analyte biomarker in conditions appropriate for binding, and detecting and/or quantifying binding of the analyte to said test substance.

High-throughput screening technologies based on the biomarker, uses and methods of the invention, e.g. configured in an array format, are suitable to monitor biomarker signatures for the identification of potentially useful therapeutic compounds, e.g. ligands such as natural compounds, synthetic chemical compounds (e.g. from combinatorial libraries), peptides, monoclonal or polyclonal antibodies or fragments thereof, which may be capable of binding the biomarker.

Methods of the invention can be performed in array format, e.g. on a chip, or as a multiwell array. Methods can be adapted into platforms for single tests, or multiple identical or multiple non-identical tests, and can be performed in high throughput format. Methods of the invention may comprise performing one or more additional, different tests to confirm or exclude diagnosis, and/or to further characterise a condition.

The invention further provides a substance, e.g. a ligand, identified or identifiable by an identification or screening method or use of the invention. Such substances may be capable of inhibiting, directly or indirectly, the activity of the analyte biomarker, or of suppressing generation of the analyte biomarker. The term “substances” includes substances that do not directly bind the analyte biomarker and directly modulate a function, but instead indirectly modulate a function of the analyte biomarker. Ligands are also included in the term substances; ligands of the invention (e.g. a natural or synthetic chemical compound, peptide, aptamer, oligonucleotide, antibody or antibody fragment) are capable of binding, suitably specific binding, to the analyte.

The invention further provides a substance according to the invention for use in the treatment of schizophrenia or other psychotic disorder, or predisposition thereto.

Also provided is the use of a substance according to the invention in the treatment of schizophrenia or other psychotic disorder, or predisposition thereto.

Also provided is the use of a substance according to the invention as a medicament.

Yet further provided is the use of a substance according to the invention in the manufacture of a medicament for the treatment of schizophrenia or other psychotic disorder, or predisposition thereto.

A kit for diagnosing or monitoring schizophrenia or other psychotic disorder, or predisposition thereto is provided. Suitably a kit according to the invention may contain one or more components selected from the group: a ligand specific for the analyte biomarker or a structural/shape mimic of the analyte biomarker, one or more controls, one or more reagents and one or more consumables; optionally together with instructions for use of the kit in accordance with any of the methods defined herein.

The identification of biomarkers for schizophrenia or other psychotic disorder permits integration of diagnostic procedures and therapeutic regimes. Currently there are significant delays in determining effective treatment and hitherto it has not been possible to perform rapid assessment of drug response. Traditionally, many anti-psychotic therapies have required treatment trials lasting weeks to months for a given therapeutic approach. Detection of an analyte biomarker of the invention can be used to screen subjects prior to their participation in clinical trials. The biomarkers provide the means to indicate therapeutic response, failure to respond, unfavourable side-effect profile, degree of medication compliance and achievement of adequate serum drug levels. The biomarkers may be used to provide warning of adverse drug response. Biomarkers are useful in development of personalized brain therapies, as assessment of response can be used to fine-tune dosage, minimise the number of prescribed medications, reduce the delay in attaining effective therapy and avoid adverse drug reactions. Thus by monitoring a biomarker of the invention, patient care can be tailored precisely to match the needs determined by the disorder and the pharmacogenomic profile of the patient, the biomarker can thus be used to titrate the optimal dose, predict a positive therapeutic response and identify those patients at high risk of severe side effects.

Biomarker-based tests provide a first line assessment of ‘new’ patients, and provide objective measures for accurate and rapid diagnosis, in a time frame and with precision, not achievable using the current subjective measures.

Furthermore, diagnostic biomarker tests are useful to identify family members or patients at high risk of developing schizophrenia or other psychotic disorder. This permits initiation of appropriate therapy, or preventive measures, e.g. managing risk factors. These approaches are recognised to improve outcome and may prevent overt onset of the disorder.

Biomarker monitoring methods, biosensors and kits are also vital as patient monitoring tools, to enable the physician to determine whether relapse is due to worsening of the disorder, poor patient compliance or substance abuse. If pharmacological treatment is assessed to be inadequate, then therapy can be reinstated or increased; a change in therapy can be given if appropriate. As the biomarkers are sensitive to the state of the disorder, they provide an indication of the impact of drug therapy or of substance abuse.

The following study illustrates the invention.

The aim of this study was to investigate expression levels of plasma supernatant analytes in response to cell stimulation. Furthermore, plasma analytes may also be of use as diagnostic biomarkers due to their accessibility. An ex vivo whole blood culture system (TruCulture) was employed to profile the expression levels of 25 cytokines, 65 other immunological and 17 metabolic markers in plasma supernatants of drug-naive schizophrenia patients and healthy controls. This allowed for monitoring immunological responses that are reflective of cell behaviour under a given physiological condition as no cell isolation or other experimental perturbations were necessary prior to analysis.

### Methodology

### Study Population

The study was approved by the local ethics committees and conducted from 2008 to 2009 at the University Hospital of Cologne and at the Central Institute of Mental Health, Mannheim, Germany. Initially, 4 mL of whole blood were collected between 8 and 10 am from fasted subjects comprising 9 antipsychotic-naive (AN) patients suffering from first-episode paranoid psychosis (DSM-IV: 295.30) and 9 healthy controls (HC) with no family history of schizophrenia or detectable medical, psychiatric or neurological history. In addition, a validation cohort comprising 8 AN patients and 8 HC subjects was collected after completion of the first sample cohort (Table 1).

TABLE 1
Demographic details of study cohorts

| | 1^{st} cohort | | 2^{nd} cohort | |
|---|---|---|---|---|
| Demographic parameter | HC | SZ | HC | SZ |
| Number (n) | n = 9 | n = 9 | n = 8 | n = 8 |
| Age (y)* | 30.0 ± 8.2 | 29.1 ± 9.8 | 28.6 ± 5.5 | 29.6 ± 6.9 |
| Gender (m/f) | 3/6 | 3/6 | 3/5 | 3/5 |
| BMI* | 23.1 ± 3.2 | 23.6 ± 6.8 | 24.7 ± 3.8 | 22.4 ± 2.3 |
| Smoking (yes/no) | 5/4 | 5/4 | 5/3 | 5/3 |
| Cannabis (yes/no) | 5/4 | 5/3/1 | 6/2 | 3/5 |

*(mean ± SD)
Abbreviations:
HC, healthy control;
SZ, drug-naive, first onset schizophrenia patients;
SD, standard deviation;
m, male;
f, female;
y, years;
BMI, body mass index

HCs were matched for age, gender, smoking, ethnicity, cannabis use, body mass index (BMI) and education and screened for medical disorders such as diabetes, heart disease, thyroid disease, autoimmune disease, recent infections or current or previous psychiatric illnesses using DSM-IV criteria. Psychopathology of the patients was assessed on the day of blood withdrawal. No cannabis use within the 6 months preceding sample collection was allowed. All schizophrenia and HC subjects showed a negative urine drug screening for illicit drugs. All patients and HCs gave written informed consent.

### TruCulture Sample Collection

Blood was collected into TruCulture systems manufactured at Experimental & Diagnostic Immunology (EDI) GmbH Company, Germany (www.edigmbh.de). In brief, TruCulture systems allow for ex vivo culturing of whole blood components without prior need for cell isolation. This has the advantage of minimising artefacts introduced by cell separation techniques and allows for physiological immune responses as close to the in vivo situation as possible. TruCulture tubes were designed to contain a) RPMI-1640 medium with no additional stimulant (unstimulated, US) or b) RPMI-1640 medium supplemented with staphylococcus enteretoxin B (SEB) and CD28 (stimulated, ST) and stored at −20° C. until use. One tube of each type was collected per patient and matching HC and within 15 min transferred to a thermo block and incubated at 37° C. for 24 h. Plasma supernatant was separated from whole blood cells using a provided valve septum and the tubes stored at −80° C. until analysis.

### Multi Analyte Profiling of Cell Supernatants

A total of 107 analytes (Human MAP®) were measured in plasma supernatants of schizophrenia patients and HCs using multiplexed immunoassays at Rules Based Medicine, Austin, Tex., USA as described previously (Bertenshaw, G. P. et al. Cancer Epidemiol Biomarkers Prev 17, 2872-2881 (2008).). Sample cohorts were measured subsequently in order to validate findings of the first profiling study. In addition, expression levels of TGF-β1 were quantified simultaneously in plasma supernatants of all samples by commercially available enzyme-linked immunoabsorbent assay (ELISA, R&D Systems, USA) following the manufacturer's specifications.

### Statistical Analysis

Among all detected molecules, 11.2% and 12.5% of the data in the first and second dataset were missing and assigned a value of 0.0. Data were analyzed after log-transformation for which a small constant (0.05) was added to all values. Each dataset featured readouts of identical samples in an US and ST condition. Statistical analysis was performed in two steps. First, repeated measures analysis of variance (ANOVA) was used to investigate the main effects of disease and stimulation as well as the interaction between these two factors. Second, the difference between patients and controls in unstimulated samples was investigated using analysis of covariance (ANCOVA). Age, sex, body mass index (BMI), smoking and cannabis consumption were included as covariates. Interactions between diagnosis and the above mentioned covariates were tested. A P-value of p<0.05 was considered to indicate statistical significance.

### Correlation and Ingenuity Pathway Analysis Networks

Correlation analysis of the reproducible differentially expressed analytes was performed in Prism v5.0 (Graph Pad Software, La Jolla, USA) using Pearson correlation. Correlations were calculated for all possible combinations of analytes and considered significant for a correlation coefficient of P>0.4 or P<−0.4 and a P-value of p<0.05. Correlation networks were generated based on significant interactions (indicated through lines) between analytes. Ingenuity Pathway Analysis (IPA) networks were generated using the Ingenuity Pathway Knowledgebase (IPKB) software as described previously (Xin-Yu Liu, PROTEOMICS 8, 582-603 (2008)).

### Results

### Assessment of Data Quality and Data Structure

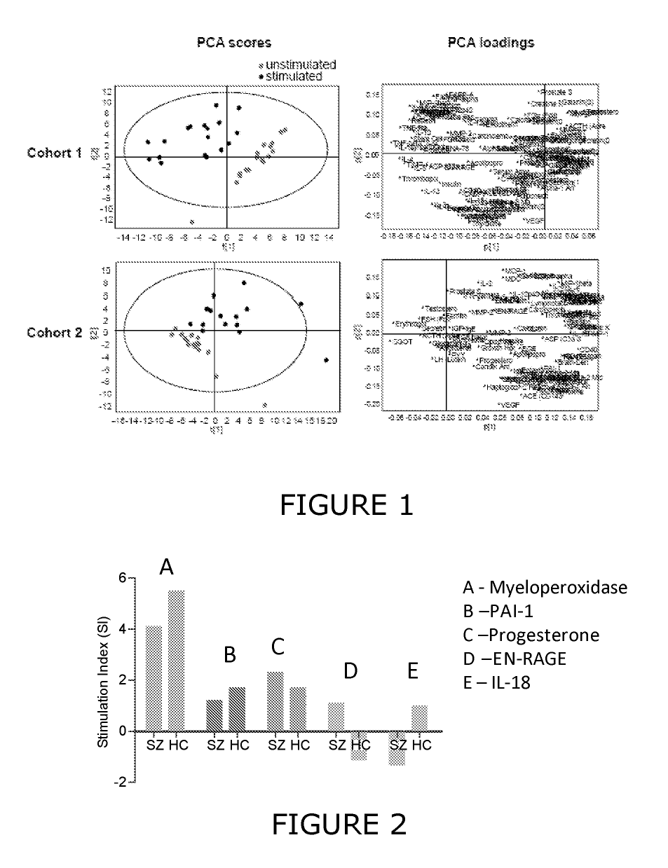

TruCulture systems containing medium with or without stimulant were employed to investigate differential ex vivo immune responses between antipsychotic-naive (AN) schizophrenia patients and healthy controls (HCs). Blood samples were collected and analytes measured independently in two cohorts (Table 1). Cohort 1 comprised 9 patients and 9 HC subjects whereas cohort 2 (validation cohort) comprised 8 patients and 8 HC subjects. Principle component analysis (PCA) was employed to assess the effect of stimulation on plasma concentration levels of measured analytes. The left panels of FIG. 1 show distinct separations in both cohorts between unstimulated (US) and stimulated (ST) TruCulture systems. This demonstrates that an immune response was evoked upon stimulation with SEB and CD28 resulting in the altered expression levels of measured analytes in plasma supernatants. The right panels of FIG. 1 show the PCA loading plots generated based on all measured analytes (n=107). Loading plots show the contribution of measured analytes to the variance of the dataset. Three different clusters can be distinguished in each loading plot. Analytes within one cluster correlate with each other based on their contribution (increased, decreased or unchanged expression levels after stimulation) to the separation between US and ST samples.

### Differentially Expressed Analytes Between Patients and Controls Independent of Stimulation

Differentially expressed analytes in plasma supernatants of US TruCulture systems were initially identified for cohort 1 using analysis of covariance (ANCOVA). Analytes were stratified for underlying baseline characteristics including cannabis, smoking, age, gender and BMI. This is important as factors such as smoking and cannabis are well known to effect immune related parameters (Sopori, M. L. & Kozak, W. J Neuroimmunol 83, 148 56 (1998); Molina-Holgado, E., Guaza, C., Borrell, J. & Molina-Holgado, F. BioDrugs 12, 317-26 (1999)) and could mask results and data interpretation. It was found, that 9 analytes were differentially expressed (p<0.05) between AN patients and HC subjects (Table 2).

TABLE 2
Altered analytes in schizophrenia patients
irrespective of stimulation condition

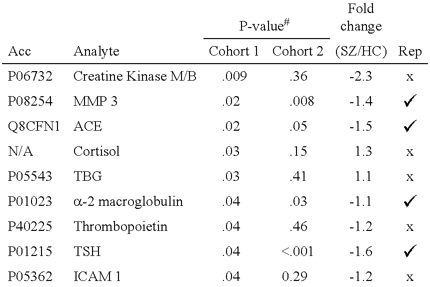

^{#}ANCOVA for unstimulated TruCulture systems
Abbreviations: Acc, Swiss-Prot accession; SZ, drug-naive schizophrenia patient; HC, healthy control; Rep, reproducibility across cohorts with non-conflicting fold change; (✓) = reproducible and (x) = not reproducible; MMP, matrix metallopeptidase; ACE, angiotensin converting enzyme; TBG, thyroxine binding globulin; TSH, thyroid stimulating hormone; ICAM, Inter-cellular adhesion molecule.

To validate these findings the same statistical method was applied to the second cohort, which identified 22 differentially expressed analytes (data not shown). Reproducibility was defined as a significant difference in both cohorts with non-conflicting fold change. The most reproducible analytes (n=4) are highlighted in the right column of Table 2. These include matrix metallopeptidase 3 (MMP3), angiotensin converting enzyme (ACE), α-2 macroglobulin (A2M) and thyroid stimulating hormone (TSH). All analytes were significantly decreased in US plasma supernatants from patients compared to those from HCs (indicated by the fold change in Table 2) and remained decreased in the ST condition (data not shown).

### Differentially Expressed Analytes Between Schizophrenia Patients and Controls Dependent on Stimulation Condition

It was also of interest to investigate whether stimulation of the TruCulture systems evoked a physiologically different response between AN patients and HC subjects and whether this difference was reflected in the differential expression of analytes secreted to plasma supernatants. The results presented in Table 3 show that 11 analytes were identified in cohort 1 that fulfilled these criteria.

TABLE 3
Altered analytes in schizophrenia patients depending on
stimulation condition

| | | | | Fold change | | |
|---|---|---|---|---|---|---|
| | | P-value^{#} | | (SZ/HC) | | |
| Acc | Name | Cohort 1 | Cohort 2 | US | ST | Rep |
| P05231 | IL-6 | .01 | .99 | 3.5 | −1.1 | x |
| N/A | Progesterone | .01 | .08 | 1.3 | 1.0 | ✓* |
| Q14116 | IL-18 | .02 | .006 | −1.4 | −1.1 | ✓ |
| P80511 | ENRAGE | .02 | .02 | 1.5 | 1.0 | ✓ |
| P05121 | PAI-1 | .02 | .08 | −1.2 | 1.0 | ✓* |
| P01133 | EGF | .03 | .21 | −1.2 | 1.0 | x |
| P41159 | Leptin | .03 | .21 | −1.1 | 1.2 | x |
| P05164 | Myeloperoxidase | .03 | .07 | 1.2 | −1.1 | ✓* |
| P40225 | Thrombopoietin | .03 | .52 | −1.2 | 1.0 | x |
| P01015 | Angiotensinogen | .05 | .35 | −1.3 | −1.8 | x |
| P21583 | Stem Cell Factor | .05 | .38 | −1.2 | 1.2 | x |

^{#}repeated measures ANOVA calculating significant interaction between diagnosis (diseased/healthy) and stimulation condition (unstimulated/stimulated)
Abbreviations:
Acc, Swiss-Prot accession;
SZ, drug-naive schizophrenia patient;
HC, healthy control;
Rep, reproducibility across cohorts with non-conflicting fold change;
✓ = reproducible,
✓* = reproducible with borderline significance levels and
x = not reproducible;
IL, interleukin;
PAI, plasminogen activator inhibitor;
EGF, epidermal growth factor

Of these, 5 (progesterone, IL-18, ENRAGE, plasminogen activator inhibitor 1 (PAI-1) and myeloperoxidase) were reproduced in the second cohort which identified in total 15 differentially expressed analytes (data not shown). Note that P-values indicate whether the interaction “diagnosis” and “stimulation condition” was significant. Therefore, analytes can be differentially expressed between patients and HCs in either of the given stimulation conditions but not necessarily in both. For example, ENRAGE, progesterone and plasminogen activator inhibitor-1 (PAI-1) show a difference in expression levels (as indicated by the fold change) for the US condition. In the ST condition, the expression levels of these analytes are equal between patients and HCs. The change in expression can further be quantified by the stimulation index (SI, ratio ST/US) which is shown in FIG. 2 for the most reproducible findings. It can be seen that the SI of myeloperoxidase, IL-18 and ENRAGE was positive for patients and HCs upon stimulation. In contrast, expression levels of progesterone and PAI-1 changed in opposite directions between patients and HCs upon stimulation.

### Correlation Analysis of the Reproducible Analytes

Pearson correlation was employed to assess whether expression levels of the 9 reproducible analytes correlated with each other adding further validation to the results on the molecular level (FIG. 3A). All analytes were analysed in combination because changes on the molecular level are intermittently linked to each other and could have effects on immune response whether in an US or ST condition. Significant interactions were found for A2M which correlated positively (P>0.4, p<0.05) with PAI-1 and ACE and negatively with MMP3 (P>−0.4, p<0.05). PAI-1 and ACE further correlated with IL-18 and TSH. These six analytes formed a single correlation network and in addition mapped to the highest scoring Ingenuity Pathway Analysis (IPA) network (FIG. 3B, left) with the associated network functions protein degradation and cardiovascular system development and function. ENRAGE and myeloperoxidase (MYO) formed a separate correlation network which also mapped to a separate IPA network (FIG. 3B, right) with the associated network functions antigen presentation and cell-mediated and humoral immune response. Progesterone did not correlate with any other analyte.

As all patients were acutely psychotic at the time of blood withdrawal, cortisol levels were also measured in plasma supernatants as an indicator of stress and correlated with the differentially expressed analytes. No significant differences in cortisol levels and no significant correlations between cortisol and any of the reproducible analytes in US or ST samples from patients and controls were found (data not shown) suggesting that stress had no impact on these analytes.

### Molecular Pathways Altered in Schizophrenia

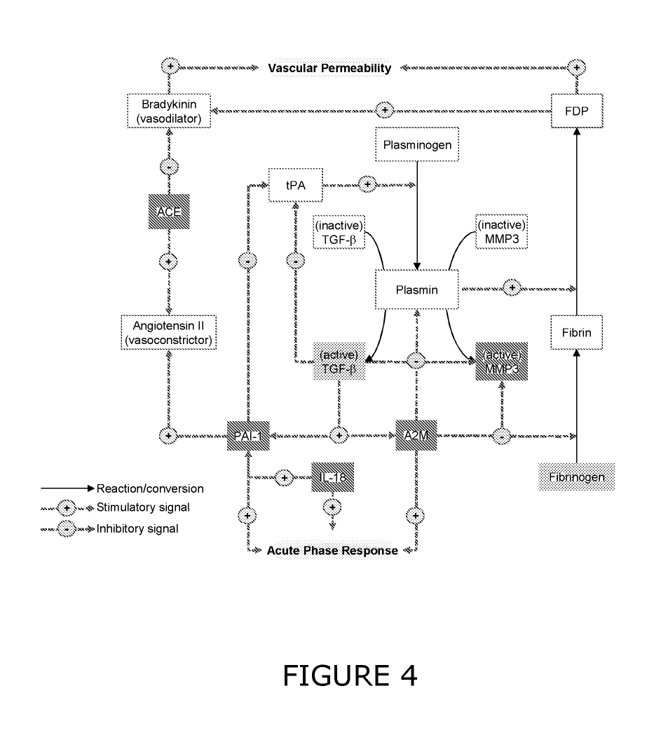

Using IPA software, the two most significant canonical pathways associated with the 9 differentially expressed analytes were the acute phase response (A2M, II-18 and PAI-1, p=9.2E-05) and the coagulation/fibronolytic system (A2M and PAI-1, p=1.72E-04). Interestingly, both pathways are connected through 5 out of the 9 differentially expressed analytes all of which were significantly decreased in patients when compared to controls (FIG. 4). TGF-β was identified as a key component within the network exerting an inhibitory role on MMP-3 and a stimulatory role on PAI-1 and A2M (Moshage, H. J Pathol 181, 257-66 (1997)). Therefore, the expression levels of TGF-β in plasma supernatants of all patient and control samples were measured in a separate ELISA assay. The same statistical analysis was applied as for the other analytes, however, no difference in TGF-β expression between patients and controls in either of the stimulation condition was found. Furthermore, expression levels of fibrinogen, a protein involved in coagulation/fibrinolysis, were also similar between patients and controls.

### Discussion

This study aimed to identify physiological dynamic differences in immune and metabolic responses between AN schizophrenia patients and HC subjects. Two well-matched and independent sample cohorts from two different clinical centres were recruited taking the above mentioned influencing factors into account. Simultaneous measurement of 107 immune and metabolic parameters was performed using an ex vivo whole blood cell culture system. Whole blood cells were cultured with or without stimulant (SEB+CD28) allowing for the assessment of functional immune responses over time. This resulted in the identification of 9 analytes that were differentially expressed between AN schizophrenia patients and HC subjects. Although all of these analytes have been linked in some aspect to schizophrenia before, they have never been identified together in the biological context demonstrated here. Interestingly, analytes that were significantly decreased (PAI-1, ACE, MMP3, TSH, IL-18, A2M) in schizophrenia patients formed a separated correlation network from analytes that were increased in patients (MYO, ENRAGE). Although most analytes have in common their involvement in endothelial dysfunction and inflammation, these two networks could represent antagonistic roles in these processes (Goldberg, R. B. J Clin Endocrinol Metab, jc.2008-2534 (2009); Dinarello, C. A. Clin Exp Rheumatol 20, S1-13 (2002); Pietzsch, J. & Hoppmann, S. Amino Acids 36, 381-389 (2009)).

The endothelial system contributes to the activation of acute phase reactions which in turn activate the coagulation/fibrinolytic system leading to altered vascular permeability (Ballantyne, C. M. & Nambi, V. Atherosclerosis Supplements 6, 21-29 (2005)). The interplay between these systems is tightly regulated through acute phase proteins (APPs), fibrin degradation products (FDRs) and vasoconstrictors such as angiotensin II (FIG. 4). Decreased levels of ACE in patients could suggest reduced levels of angiotensin II and increased levels of bradykinin, a vasodilator that increases leukocyte migration, sensitivity to pain and vascular permeability (Fujisawa, H et al, J Neurol Neurosurg Psychiatry 59, 388-394 (1995)). Interestingly, elevated skin flush responses to niacin, a potent inducer of vasodilatation, have been consistently reported in schizophrenia demonstrating their compromised vasodilating capacities (Glen, A. I. M. et al. Prostaglandins, Leukotrienes and Essential Fatty Acids 55, 9-15 (1996); Nilsson, B. M et al, Prostaglandins, Leukotrienes and Essential Fatty Acids 74, 339-346 (2006); Messamore, E. et al, Schizophrenia Research 62, 251-258 (2003)). This could be explained by increased levels of MYO which binds endothelial-derived nitric oxide and thereby reduces its vasodilating and anti-inflammatory properties (Loria, V. et al, Mediators Inflamm 2008, 135625 (2008)). Reduced levels of ACE might therefore be an attempt to attenuate vasodilatation in schizophrenia patients and stimulate the release of prostaglandins, which activate endothelial cells and therefore cause vasodilatation (Nielsen, J. et al. Proceedings of the National Academy of Sciences 105, 3634-3639 (2008)).

In addition, decreased levels of TSH have been associated with vascular endothelial dysfunction and are a common feature of clinical hyperthyroidism (Maji, D. J Indian Med Assoc 104, 563-4, 566-7 (2006)). TSH, PAI-1 and A2M are also inhibitors of the coagulation/fibrinolytic system (de Boer, J. P. et al. Infect. Immun. 61, 5035-5043 (1993)). Decreased expression of these markers in schizophrenia patients could imply an increase in coagulation products (e.g. fibrin) and thus fibrinolysis resulting in the production of FDRs and increased vascular permeability. Under inflammatory conditions vascular permeability is increased in order to promote leukocyte trafficking to the site of inflammation (Aghajanian, A. et al, Journal of Thrombosis and Haemostasis 6, 1453-1460 (2008)). Although levels of APPs associated with the positive acute phase response are also increased under inflammatory conditions (Pannen, B. H. & Robotham, J. L. New Horiz 3, 183-97 (1995)) the expression levels of the APPs IL-18, A2M and PAI-1 were decreased in the US condition in patients compared to controls. Thus, decreased expression of these APPS could suggest that there is no inflammatory component underlying schizophrenia illness in the first stages of the disease. However, they could also suggest a failure in the immune system of schizophrenia patients to induce an inflammatory immune response and restore tissue homeostasis, as under normal circumstances, the acute phase response is initiated to counterbalance tissue injury/damage by upregulation of inflammatory markers (Moshage et al, supra). This could be compensated by an increase in vascular permeability in schizophrenia patients. In fact, abnormalities of the vascular system such as a disturbed cerebral or brain blood flow have repeatedly been associated with schizophrenia and have led to the concept of “hypofrontality” (Hanson, D. & Gottesman, I. BMC Medical Genetics 6, 7 (2005)).

A key-regulator of the coagulation/fibrinolytic system is PAI-1 which indirectly inhibits the plasma protease plasmin through inactivation of tissue plasminogen activator (tPA) a facilitator of the conversion from plasminogen to plasmin (Moshage et al, supra). Plasmin converts inactive TGF-β and MMP3 to their biological active forms (Moshage et al, supra). Whereas expression levels of MMP3 were found to be decreased in patients, those of TGF-β were found to be similar between patients and controls. This is not surprising as TGF-β plays dual roles and controls its own activation through activation of PAI-1 and inhibition of tPA, thus reducing plasmin levels, a potent inducer of TGF-β (Rieder, H. et al, Hepatology 18, 937-44 (1993)). Interestingly, increased levels of plasminogen in schizophrenia patients have been reported which adds further support to these results (Seal, U. S. & Swaim, W. R. Clin Chem 14, 368-370 (1968)). In contrast, Carrizo et al. reported increased levels of PAI-1 in schizophrenia patients (Carrizo, E. et al. Schizophrenia Research 103, 83-93 (2008)). However, these patients were chronically ill and under clozapine-treatment whereas the patients investigated in this study were drug-naive and at disease onset. In another treated patient cohort, Tanaka et al. found increased levels of IL-18 in serum of schizophrenia patients (Tanaka, K. F. et al, Psychiatry Res 96, 75-80 (2000)). Increased expression of A2M has been reported in serum of male Chinese schizophrenia patients whereas Bock et al. found decreased levels of A2M in newly admitted schizophrenia patients suffering from acute psychosis (Tanaka et al, supra; Bock, E., Weeke, B. & Rafaelsen, O. J. Journal of Psychiatric Research 9, 1-9 (1971)). In general, the acute phase response and the activation of an inflammatory response in schizophrenia have mostly been associated with increased levels of positive APPs or inflammatory markers such as complement factor C, α-antitrypsin or IL-6 (Ganguli, R. et al. Psychiatry Res 51, 1-10 (1994); Maes, M. et al. European Neuropsychopharmacology 10, 119-124 (2000); Maes, M. et al. Psychiatry Research 66, 1-11 (1997); Yang, Y. et al. Analytical Chemistry 78, 3571-3576 (2006)). However, most studies investigated the response of inflammatory markers to medication or used treated patient cohorts, whereas here, samples from AN and first-onset schizophrenia patients were used allowing for the detection of differentially expressed analytes without the confounding effect of medication. Other possible explanations for this discrepancy could be the use of different assay technologies. The advantage of this study lies in the use of an ex vivo culture system that does not require sample handling prior to analysis thus reflecting a condition that is as close as possible to the in vivo situation.

Inflammation and vascular abnormalities are all mechanisms that are not limited to schizophrenia illness alone. They are common responses to physiological and pathological events that are also found in countless other diseases such as rheumatoid arthritis (Libby, P. The American Journal of Medicine 121, S21-S31 (2008)) or Alzheimer's (Wyss-Coray, T. Nat Med 12, 1005-15 (2006)) and are particularly vulnerable to stress. This further complicates schizophrenia research and highlights the difficulty of finding consistent molecular signatures that are specific for the illness. There is compelling evidence that psychosis is linked to psychosocial stressors and that schizophrenia patients respond emotionally stronger to stress than healthy subjects (van Winkel, R., Stefanis, N. C. & Myin-Germeys, I. Schizophr Bull 34, 1095-1105 (2008)). To account for physiological stress associated with acute psychosis and to exclude potential false positive results cortisol levels were measured. Firstly, cortisol levels were not significantly different in plasma supernatants of schizophrenia patients when compared to controls. Secondly, no significant correlations between plasma supernatant analytes and cortisol were found suggesting that these analytes were not altered as a response to stress. These results also show that markers involved in stress pathways may well be specific for schizophrenia.

In conclusion, this study resulted in the identification of 9 differentially expressed plasma supernatant analytes between schizophrenia patients and HC subjects. Using an ex vivo culturing system that required minimal sample handling we showed that it is possible to identify robust immune and metabolic signatures for schizophrenia which were successfully reproduced in two independent study cohorts and clinical centres despite low sample numbers. The correlation between these analytes on the molecular level further highlights their biological role in inflammation which is manifested in altered expression of proteins associated with the acute phase response and the coagulation/fibrinolytic system.

1-9. (canceled)

10. A method of diagnosing schizophrenia or other psychotic disorder, comprising:
a) quantifying the amounts of a panel of analyte biomarkers in a sample from a test subject;
b) comparing the amounts of the biomarkers present in the sample with one or more controls;
c) diagnosing the test subject as suffering from schizophrenia or other psychotic disorder based at least in part on a difference between the amounts of the biomarkers present in the sample and the control, and
d) treating the test subject with anti-psychotic therapy,
wherein the panel of analyte biomarkers comprises Matrix Metallopeptidase-3 (MMP-3), Thyroid Stimulating Hormone (TSH) and IL-18.

11. (canceled)

12. (canceled)

13. (canceled)

14. (canceled)

15. The method of claim 10, further comprising detecting a change in the amounts of the biomarkers in samples taken on two or more occasions.

16. (canceled)

17. The method of claim 10, comprising comparing the amounts of the biomarkers in the sample from the test subject with the amount of the biomarker present in a sample from a normal subject.

18. (canceled)

19. The method of claim 10, wherein samples are taken at intervals over the remaining life, or a part thereof, of the test subject.

20. The method of claim 10, wherein quantifying is performed by measuring the concentrations of the analyte biomarkers in the sample.

21. The method of claim 10, wherein quantifying is performed by one or more methods selected from SELDI (-TOF), MALDI (-TOF), a 1-D gel-based analysis, a 2-D gel-based analysis, Mass spec (MS), reverse phase (RP) LC, size permeation (gel filtration), ion exchange, affinity, HPLC, UPLC or other LC or LC-MS-based technique.

22. The method of claim 10, wherein quantifying is performed using an immunological method.

23. The method of claim 10, wherein the quantifying is performed using a biosensor or a microanalytical, microengineered, microseparation or immunochromatography system.

24. The method of claim 10, wherein the sample is cerebrospinal fluid, whole blood, blood serum, plasma, urine, saliva, or other bodily fluid, or breath, condensed breath, or an extract or purification therefrom, or dilution thereof.

25. (canceled)

26. The method of claim 10, wherein the panel of analyte biomarkers further comprises one or more additional analytes selected from: Creatine kinase-MB, Angiotensin Converting Enzyme (ACE), Cortisol, Thyroxine Binding Globulin (TBG), α-2 macroglobulin (A2M), Thrombopoietin, Inter-Cellular Adhesion Molecule-1 (ICAM-1), IL-6, EN-RAGE, Plasminogen Activator Inhibitor-1 (PAI-1), Epidermal Growth Factor (EGF), Leptin, Myeloperoxidase, Angiotensinogen and Stem Cell Factor

27. The method of claim 26, wherein the additional analytes comprise: Creatine kinase-MB, Angiotensin Converting Enzyme (ACE), Cortisol, Thyroxine Binding Globulin (TBG), α-2 macroglobulin (A2M), Thrombopoietin and Inter-Cellular Adhesion Molecule-1 (ICAM-1).

28. The method of claim 26, wherein the additional analytes comprise: Plasminogen Activator Inhibitor-1 (PAI-1), Angiotensin Converting Enzyme (ACE) and α-2 macroglobulin (A2M).

29. The method of claim 26, wherein the additional analytes comprise: IL-6, EN-RAGE, Plasminogen Activator Inhibitor-1 (PAI-1), Epidermal Growth Factor (EGF), Leptin, Myeloperoxidase, Thrombopoietin, Angiotensinogen and Stem Cell Factor.

30. The method of claim 26, wherein the additional analytes comprise: EN-RAGE, Plasminogen Activator Inhibitor-1 (PAI-1) and Myeloperoxidase.

31. The method of claim 10, wherein the panel of analyte biomarkers consists of: Matrix Metallopeptidase-3 (MMP-3), Thyroid Stimulating Hormone (TSH), IL-18, Angiotensin Converting Enzyme (ACE), α-2 macroglobulin (A2M), Progesterone, EN-RAGE, Plasminogen Activator Inhibitor-1 (PAI-1) and Myeloperoxidase.
